(19) United States
(12) Patent Application Publication
(10) Pub. No.: US 2005/0269304 A1
(43) Pub. Date: Dec. 8, 2005

(54) Laser coding

(76) Inventors: Nazir Khan, Nottingham (GB); Brian Stubbs, Nottingham (GB); Joseph Gaunt, Nottingham (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/141,298

(22) Filed: May 31, 2005

Related U.S. Application Data
(63) Continuation-in-part of application No. 11/095,422, filed on Mar. 31, 2005.
Application No. 11/095,422 is a continuation of application No. 10/344,393, filed on Feb. 10, 2003, now Pat. No. 6,888,095.

(30) Foreign Application Priority Data
Feb. 28, 2001 (GB) 0104959.2
Jun. 19, 2001 (GB) 0114977.2

(51) Int. Cl. B23K 26/00

(52) U.S. Cl. 219/121.85

(57) ABSTRACT

A method for marking an object, wherein the object comprises a material including a functional group and a metal compound or acid that causes an elimination reaction on irradiation with a laser, to form a reaction product of contrasting colour, comprises directing a laser beam on to the areas of the object to be marked For example, by using a carbohydrate and a metal salt, effective marking can be achieved on the coating of a pill or other edible material.

### REFERENCE TO RELATED APPLICATIONS

This application is a continuation-in-part of application Ser. No. 11/095,422, filed Mar. 31, 2005, which is a continuation of Ser. No. 10/344,393 filed Feb. 10, 2003, now U.S. Pat. No. 6,888,095, issued May 3, 2005, which is a national stage application of PCT/GB02/00862, filed Feb. 27, 2003, which claims priority from United Kingdom Application No. 0104959.2, filed Feb. 28, 2001.

### FIELD OF THE INVENTION

This invention relates to laser coding, particularly of edible materials.

### BACKGROUND OF THE INVENTION

Laser coding is well known; see, for example, U.S. Pat. No. 5,783,793, U.S. Pat. No. 4,906,813 and also U.S. Pat. No. 5,340,628 which seeks to contain the particles produced by ablation. These methods present a variety of problems, including difficulties in maintenance, line down-time, taint, as well as the need for extraction. More generally, the apparatus and problems of printing, i.e. ribbons, inks, solvents, maintenance, unreliability, etc., are particularly undesirable where sensitive products like foods and pharmaceuticals are packaged.

Various proposals have been made, in order to achieve effective printing without ablation, and without applying ink at the point of coding, but rather by causing a change of colour in the substrate on which the printing is to appear. Various pigments have been proposed, which can be used to mark a substrate on the application of laser energy. Some of these proposals may be found in, for example, WO-A-00/43456, JP-A-11001065, EP-A-0522370, EP-A-0797511, U.S. Pat. No. 5,053,440, U.S. Pat. No. 5,350,792 (a plastic moulding composition comprising a polyoxymethylene and animal charcoal), U.S. Pat. No. 5,928,780, U.S. Pat. No. 6,017,972 and U.S. Pat. No. 6,019,831.

On-line coding methods commonly used for the pharmaceutical, foods and confectionery industries are ink-jet and thermal transfer (including hot stamping).

### SUMMARY OF THE INVENTION

The present invention is based on the utility of particular materials which can undergo a colour change on the application of laser energy, and the realisation that these include edible materials which can therefore be used to mark materials intended for consumption. Such materials include those that undergo internal reactions on irradiation with a laser, such that a reaction product of contrasting colour is formed.

According to this invention, a method for marking an object, wherein the object comprises a material including a functional group and a metal compound or acid that causes an elimination reaction on irradiation with a laser, to form a reaction product of contrasting colour, comprises directing a laser beam on to the areas of the object to be marked.

The present invention is also a method for marking an object, wherein the object comprises a moiety including both a functional group and a metal ion, wherein the metal ion is capable of reacting with the functional group to cause an internal elimination reaction on irradiation with a laser, to form a reaction product of contrasting colour, and wherein this method comprises directing a laser beam onto the areas of the object to be marked, whereby those areas are marked by the presence of said reaction product.

Optionally, the functional group within the moiety does not react with metal ions present in any additional substances contained within the object.

Depending on the nature of the components that are used, and the reaction product, they may be physiologically acceptable. This means that the invention can be used in the making of foodstuffs and pharmaceutical products such as tablets and pills.

The method of the present invention overcomes the problems associated with printing, as described above. It allows significant cost savings for most normal production lines, and the opportunity to improve on the quality of the coding produced on foodstuffs and other products. Further advantages of the invention are that it can be highly reliable, involves low maintenance costs, and avoids solvents, emissions, debris and extraction. The invention provides on-line, non-contact coding, with reduced line down-time. The method of the invention can be used to replace all current coding systems, at the highest line speeds. There is no need for the purchase or stocking of materials associated with printing, and yet the quality of print can be improved. Adhesion problems and smudging can be avoided. There is no need to pierce wrapping film. Further, it is possible to code in damp conditions.

### DESCRIPTION OF THE INVENTION

In accordance with a preferred aspect of the invention, suitable additives are provided in a coating on a solid substrate, e.g. foodstuff, including confectionery, or pharmaceutical dosage units such as a tablet or pill. Such coatings are known, and may simply be modified according to the invention by inclusion of materials which react with each other, essentially to form a dye or chromophore in situ. The product is intended for consumption or (if pharmaceutical) oral administration, in which case the additive(s) and any reaction product are edible.

In one embodiment of this invention, the additives are a polyhydroxy compound and a dehydrating agent. The latter is typically a metal salt of the type that, as is known, can be used to remove OH groups (which for the purposes of this specification are functional groups) from sugars, e.g. sucrose, starches, modified starches, cellulose, modified celluloses, etc. Examples of suitable metal salts are alkali metal, alkaline earth metal, iron oxide/salts and organometallics. Thus, for example, when heated by the application of laser energy, sucrose in the presence of MgO or FeO etc. will char. Other examples of materials that will give a colour change by dehydration (elimination of water) in the presence of a metal salt include hydroxypropylcellulose, methylhydroxypropylcellulose, sodium carboxymethylcellulose, polyvinyl alcohol. Suitable metal salts for this purpose include MgCl₂, Mg(OH)₂, CaO, FeO, Fe₂O₃, SiO₃ Zn acetate, ZnO and alumino-silicates.

In a further embodiment of the invention, the elimination reaction may comprise dehalogenation, dehydrohalogenation or deacetylation, in which case the relevant functional group is a halogen atom or carboxyl group. Examples of additives for this purpose are vinyl polymers, typically in the present of a metal salt. Suitable polymers include polyvinyl chloride (PVC), polyvinyl acetate, vinyl esters, vinyl chloride/acetate copolymer and vinyl chloride/maleate copolymer. Suitable metal compounds for this purpose include ZnO, Zn salicylate, kaolin and CaSiO₃.

Yet another embodiment of the invention uses additives that undergo deetherification. Thus, for example, ethyl cellulose and a metal salt will give a colour on irradiation.

The examples given above are primarily of metal salt-induced elimination. A further embodiment of the invention is acid or base-induced dehydration/dehalogenation/dehydrohalogenation/deacetylation/deetherification. Thus, for example, a colour is generated using p-toluenesulphonic acid with PVOH (polyvinyl alcohol).

Based on this information, other suitable materials will be known, or can be readily chosen or tested for their suitability, by those of ordinary skill in the art.

In accordance with the invention, an object may comprise a moiety including both a functional group and a metal ion. On irradiation with a laser, this moiety undergoes an internal elimination reaction so as to form a reaction product in situ which is a dye or chromophore. Typically the laser is a CO₂ laser, emitting IR radiation, although diode lasers emitting NIR radiation of approximately 1500 nm are also suitable.

Generally, the elimination reaction is a dehydration reaction (i.e. elimination of water), and usually the elimination reaction results in charring of the functional group.

Usually the object comprises a substrate and, coated thereon, a coating. In this instance, the moiety is preferably contained within the coating, as are any additional chemical additives.

The object or substrate upon which the image or mark is to be made can be a foodstuff, for example confectionary, eggs or fruit, or a pharmaceutical dosage unit such as a tablet or pill. If the object or substrate is intended for consumption or (if pharmaceutical) oral administration, then the moiety and reaction product are edible. Alternatively, the object or substrate can be paper, polymer film, card or board, plastic containers, and other items capable of bearing a printed image.

The reaction product (i.e. the dye or chromophore) may be of greater colour intensity than the unreacted moiety, and preferably the unreacted moiety is substantially transparent or substantially colourless.

The functional group can include any group that will undergo an internal elimination reaction with the metal ion, but typically includes one or more groups selected from OH and/or COOH.

In one embodiment, the functional group forms part of a homopolymer or copolymer of a carbohydrate. In other words, the moiety comprises a homopolymer or copolymer of a carbohydrate. Preferably the functional group forms part of (or the moiety comprises) a polysaccharide. Examples of suitable polysaccharides include carboxymethylcellulose, hydroxypropylcellulose, alginate, or pectinate.

A preferred polysaccharide is an alginate. This is used as a flavouring/food ingredient, and can readily be marked, by means of the invention.

Starch or another edible polymer may be a component of an object to be marked. The present invention utilises this by the simple expedient of adding a salt such as sodium carbonate or bicarbonate. Such a salt may also be added to, say, sodium CMC.

In this embodiment, the metal ion is preferably a monovalent ion, for example an alkali metal, wherein sodium is most preferred. Calcium is a further example, although this is often less preferred.

In a second embodiment, the functional group can form part of (or the moiety can comprise) a dicarboxylate. Examples of suitable dicarboxylates include 1,2-dicarboxylates (oxalates), 1,3-dicarboxylates (malonates), 1,4-dicarboxylates and 1,5-dicarboxylates, although 1,3-dicarboxylates (malonates) are preferred since they decompose to a dark oxide at a lower temperature than other dicarboxylate salts, thus facilitating dark laser image formation.

In the second embodiment, the metal ion preferably comprises a divalent transition metal cation, preferably from the first row of the Periodic Table. Examples of particularly preferable metal ions include Mn²⁺, Co²⁺, Fe²⁺, Ni²⁺ and Cu²⁺. Of these, Mn²⁺ and Co²⁺ are most preferable as their salts are generally relatively pale in colour, and Fe²⁺ is often least preferred since yellow aqueous ferrous ion solutions are sometimes readily darkened by atmospheric oxygen to ferric ion.

In a third embodiment, the functional group forms part of (or the moiety comprises) an anion having the partial formula —CH(OH)CH(OH)CH(OH)COO^{⊖}—. Examples of suitable anions comprising this fragment are gluconates (HOCH₂[CH(OH)]₄CO₂⁻) and heptonates (HOCH₂[CH(OH)]₅CO₂⁻). Anions according to this embodiment can optionally be contained within a borate complex to form, for example, a boroheptonate salt, such that the functional group forms part of, or the moiety comprises, a boroheptonate salt. Typical boroheptonates contain 1 to 1.2% boron.

In the third embodiment, the metal ion is preferably a mono-, di- or tri-valent metal cation. Examples of preferred metal ions for use in the third embodiment include NH₄⁺, Li⁺, Na⁺, K⁺, Ca²⁺, Mg²⁺, Sr²⁺ and Al³⁺, where Na⁺ is particularly preferred. Cu²⁺ is generally less preferred, since its salts may be highly coloured.

A preferred aspect of all of these three embodiments is the ability to improve the intensity of an image or mark yet further by adding a substance comprising a second metal ion to either the object or the coating. It is believed that the second metal ion reacts with functional groups on the moiety that do not undergo the internal elimination reaction, so as to give rise to a larger amount of product and hence a darker colour. It is believed that only some functional groups are capable of undergoing the internal reaction due to an excess of functional groups as opposed to metal ions in the original moiety. The extra metal ions provided by the additional substance therefore allow more functional groups to react.

Substances suitable for achieving this enhanced intensity effect include substances containing a second metal ion that is the same as the metal ion present in the moiety. Such substances may be inorganic or organic in nature, and may also function as a binder. Methylcellulose salts of second metal ions are preferred. As an example, it has been shown that when sodium alginate is the moiety, sodium methylcellulose can be used to provide an enhanced intensity effect.

A further preferred aspect of all three embodiments is the ability to achieve a similar enhanced intensity effect when oxyanion-containing compounds are incorporated in to the object or the coating. The oxyanion can be a molybdate, tungstate or an analogous transition metal compound, including di- and hepta-molybdates.

The cation used in combination with the oxyanion can be an ammonium, alkali metal or alkaline earth metal cation, although this is not critical. A particularly preferred oxyanion salt is AOM, i.e. ammonium octamolybdate ((NH₄)₄Mo₈O₂₆), since this is readily available and is selective for a robust, low power CO₂ laser operating at about 10,600 nm. All disclosure within U.S. application Ser. No. 10/899,888 regarding AOM and similar oxyanion-containing compounds is incorporated herein by reference.

Based on the above information, other suitable functional groups, metal ions and intensity enhancers will be known, or can be readily chosen or tested for their suitability, by those of ordinary skill in the art.

It is within the scope of the invention that objects or substrates to be marked may be pre-wrapped, provided that the wrapping is transparent to the applied energy; in other words, film-wrapped tablets, foodstuffs or other such products can be printed by means of the present invention. Many commonly available wrapping films have been found to be transparent to IR laser energy, including PE, PP, PET, PVC, cellulose and cellulose acetate.

The space allocated on an object or substrate, or its wrapping, for the batch code, sell-by date, etc. is usually a small patch printed in a light colour to give good contrast to the (normally) black print. Using the system of the invention, this may be a white or lightly-coloured patch, which is printed with a laser-sensitive ink. On exposure to a threshold dose of laser energy, the ink changes colour to give the code. The patch may be printed down by a known printing technique, eg. by flexo or gravure, as the packaging is made.

The object to be marked may be formulated with the additional components that allow marking. In a preferred embodiment, these components are formulated and used to coat a substrate. For application to the substrate, the material or materials used in this invention may be formulated in an aqueous or non-aqueous system, as a solution or dispersion achieved by, for example, ball milling. Typically, the materials are formulated in an aqueous system comprising ethanol or a water/ethanol mix. Preferably, the materials are formulated to include a binder, for example polyvinyl alcohol or polyacrylic acid. Optionally the formulation also includes IR absorbers.

Since it may determine the clarity of the marking that can be achieved, coating may be done more than once, if desired. Further, on top of the coating, a protective layer of for example carnauba wax can be applied by a conventional coating process, provided the coatings are laser-markable through the protective layer, as is the case for carnauba wax.

The amounts of the components that are used in the invention can readily be chosen by one of ordinary skill, having regard to the intended use. For example, a coating composition may comprise 0.1 to 20% w/v of each component.

As indicated above, an image can be formed by the application of heat. Preferably, heat is applied locally, on irradiation with a laser. Suitable lasers include those emitting at high energy, including Nd—YAG lasers and CO₂ lasers, the latter typically at a wavelength of 10,600 nm. In many cases, it may be desirable to use a low-energy laser, such as diode laser, typically emitting light at a wavelength in the range of 800-1500 nm. In certain circumstances, this energy input may be insufficient to cause the desired reaction, and the composition to be irradiated then preferably comprises a suitable absorbent material.

Further additives that may be used are thus IR-absorbent materials, many of which are known. In general terms, any suitable such material may be incorporated, for the purposes of this invention, and can be chosen by one of ordinary skill in the art. A particularly preferred IR absorber for use in the invention or any related technology is a conducting polymer, by which is meant a material that, in the polymerised state, comprises linked monomers (typically rims) that are conjugated and which can therefore allow delocalisation/conduction of positive or negative charge. The conjugation allows an absorption shift that can be controlled such that it applies to the wavelength of irradiation, and which may also depend on the concentration of the polymer.

Examples of monomers that can be conjugated to give suitable conducting polymers are aniline, thiophene, pyrrole, furan and substituted derivatives thereof. Such polymers, in addition to providing the desired means of transferring heat from a low-power laser, have the advantage that they do not readily diffuse out of the coating material. They can also act as the polymer binder. Yet another advantage of such materials is that they can be colourless, even at high loading (up to 5% by weight); this is by contrast to monomeric species that have been used, such as phthalocyanine, which absorb at about 80 nm but give the composition a greenish tinge, even at a loading of 0.1% by weight.

Conjugated polymers and also salts that can function in a similar manner are described in PCT/GB2004/003219 and PCT/GB2005/000121, the contents of which are incorporated herein by reference.

A particular advantage of the invention is that the object to be marked may be pre-wrapped, provided that the wrapping is transparent to the applied energy; in other words, film-wrapped tablets or other such products can be printed by means of the present invention. Many commonly available wrapping films have been found to be transparent to IR laser energy, including PE, PP, PET, PVC, cellulose and cellulose acetate.

As indicated above, the or each additive may be responsive to UV or IR radiation, and any suitable materials may be used, provided that they can produce a colour change. The change may be due to the material undergoing chemical or physical change as a result of the absorption of laser energy, or as a result of that energy being converted to thermal energy. Thus, for example, polyvinyl alcohol is known as a coating ingredient; if a dehydrating agent such as p-toluenesulphonic acid is included in the coating, the application of energy can lead to conjugation and a colour change. Further examples of suitable materials include carbohydrates that can be caramelised, and a combination of ethylcellulose with calcium hydroxide. Preferably, the additive or an existing component will strongly absorb the radiation.

The space allocated on a package for the batch code, sell-by date, etc. is usually a small patch printed in a light colour to give good contrast to the (normally) black print. Using the system of the invention, this may be a white or lightly-coloured patch, which is printed with a laser-sensitive ink. On exposure to a threshold dose of laser energy, the ink changes colour to give the code. The patch may be printed down by a known printing technique, e.g. by flexo or gravure, as the packaging is made.

The object to be marked may be formulated with the additional components that allow marking. In a preferred embodiment, these components are formulated and used to coat a substrate. For application to the substrate, the material or materials used in this invention may be formulated in an aqueous or non-aqueous system, as a solution or dispersion. For coating on pills, the transparency of the coating is not usually a consideration, but the use of a solution of components may be preferred, in order to provide a clear coating on certain substrates. Since it may determine the clarity of the marking that can be achieved, coating may be done more than once, if desired.

The amounts of the components that are used in the invention can readily be chosen by one of ordinary skill, having regard to the intended use. For example, a coating composition may comprise 0.1 to 20% w/v of each component.

It has been demonstrated that, in accordance with the invention, single or multiple layers of water-based edible laser-scribable coatings can be applied to unpolished or polished tablets by a conventional tablet coating process. On top of the coating, a layer of the carnauba wax can be applied by a conventional coating process without any difficulty.

Tablets coated with three or more layers of the water-based edible coatings are markable with CO₂ laser and afford good quality grey/green laser marking. The coatings are laser-markable through the layer of carnauba wax.

Typically, the necessary energy will be a laser beam. For example, a print engine for an IR coding system comprises a robust, low-power CO₂ laser, e.g. operating at about 10,600 nm. The laser can operate in either the dot matrix mode or continuous-wave, scribing mode. In this latter mode, improved quality of print can be obtained. Because of the low output of the laser, highly reliable, approaching maintenance-free, operation is offered. The system can operate in a scribe mode, and coding onto moving lines at up to 200 m/min is possible. For higher speeds than this, dot matrix printing is suitable.

The system can be used for coding through packing film, or coding into film laminates. A low-power laser ensures that puncturing does not occur.

The following Examples illustrate the invention.

### EXAMPLES 1 to 12

Materials etc are shown in the following Table. Those of Examples 9 to 12 are particularly suitable for use as an edible composition.

In each case, a lacquer was mixed, coated and dried before marking with a CO₂ laser, using a beam of 0.3 mm diameter and scan speed of 1000 mms⁻¹. Vinnol is a vinyl chloride/acetate copolymer supplied by Stort Chemicals. Vycar is a copolymer of vinyl chloride and an acrylic acid supplied by Goodrich.

| | | Quantity | | Quantity | | Quantity | Laser Power | Colour |
|---|---|---|---|---|---|---|---|---|
| Example | Binder | (g) | Additive | (g) | Solvent | (g) | (W) | of Image |
| 1 | Vinnol 14/36 | 5 | Zinc chloride | 0.5 | MEK | 8 | 5 | Black |
| 2 | Vinnol 14/36 | 5 | Zinc oxide | 1 | MEK | 10 | 6-7 | Black |
| 3 | Vinnol 14/36 | 3 | Zinc oxide | 0.3 | MEK | 6 | 5-6 | Black |
| | | | Calcium silicate | 0.2 | | | | |
| 4 | Vinnol 14/36 | 3 | Zinc oxide | 0.3 | MEK | 6 | 5-6 | Black |
| | | | Kaolin | 0.3 | | | | |
| 5 | Vinnol 14/36 | 2 | Calcium silicate | 0.3 | MEK | 5 | 5-6 | Yellow |
| 6 | Vinnol 14/36 | 4 | Zinc 3,5-di-tert | 1 | MEK | 10 | 5-6 | Black |
| | | | butyl salicylate | | | | | |
| 7 | Vinnol 14/36 | 3 | Irgacure 261 | 1 | MEK | 6 | 5-6 | Black |
| 8 | Vycar 577-E | 10 | Zinc Oxide | 1 | Water | 4.8 | 3 | Yellow |
| 9 | Klucel (hydroxy | 2 | Magnesium | 1 | Water | 15 | 5-6 | Yellow |
| | propyl cellulose) | | chloride | | | | | |
| 10 | Culminal (methyl | 1 | Magnesium | 1 | Water | 10 | 5-6 | Yellow |
| | hydroxy propyl | | chloride | | | | | |
| | cellulose) | | | | | | | |
| 11 | Ethyl cellulose | 2 | Calcium hydroxide | 1 | Ethanol | 15 | 6-7 | Yellow |
| 12 | Blanose (sodium | 1.5 | Calcium hydroxide | 1 | Water | 10 | 6 | Yellow |
| | carboxy methyl | | | | | | | |
| | cellulose) | | | | | | | |

### EXAMPLE 13

100 g sodium carboxymethylcellulose was added portionwise to 2000 g water, with stirring. Once the addition was complete, stirring was continued until complete dissolution of the polymer was achieved.

100 g MgCl₂.6H₂O was added portionwise to the polymer solution. After the addition was complete, the mixture was stirred for approx. 10 min, to give a coating solution.

2 kg tablets were charged into a coating pan. The coating pan containing the tablets was rotated at constant speed, and then the tablets were warmed up to 50° C. using a hot air dryer.

For a first coating layer, 10 ml of the coating solution was added and the coating pan was allowed to rotate at constant speed and ambient temperature for approximately 10-15 minutes. The coated tablets were warmed to approximately 50° C. with a hot air dryer whilst the pan was rotated at constant speed. A 200 g sample of the coated tablet was taken. Using two more 10 ml volumes of the coating solution, the coating procedure was repeated twice.

Laser marking of the coated tablets was investigated using a 10 W Alltec CS smart carbon dioxide laser. Parameters used for the marking of the tablets are presented below:

| | | |
|---|---|---|
| Laser frequency | 20000 | Hz |
| Power | 7 | Watts |
| Scan velocity | 500 | mm/sec |
| Line width | 50 | μm |
| Lens | 200 | mm |

A reasonable dark grey/green image was obtained.

### EXAMPLE 14

The procedure of Example 13 was repeated, except that the tablet was polished, i.e. a final coat of wax was applied by the addition of 805 mg of a 50% ethanolic solution of carnauba wax to the coating pan. Again, a reasonable dark grey/green image was obtained. The same result was obtained if the tablet was polished underneath, i.e. if the coating of laser-sensitive material was on top of a coating of carnauba wax.

### EXAMPLE 15

The procedure of Example 13 was repeated, but using a solution obtained from 30 g sodium carboxymethylcellulose, 30 g MgCl₂.6H₂O and 400 g water. A good grey/green image was obtained, with or without polishing (as described in Example 14).

### EXAMPLE 16

The procedure of Example 13 was repeated, but using a coating solution obtained by adding 750 g Vinnol 14/36 portionwise to 1500 g 2-butanone (MEK) with stirring, until the addition is complete, followed by stirring until dissolution of the polymer is complete, followed by the addition of 150 g zinc oxide portionwise with stirring, and for 30 minutes after addition is complete, to disperse the zinc oxide uniformly. Laser marking gave a dark black image.

### EXAMPLE 17

When a solid sample of sodium alginate was irradiated using a Videojet Focus S10 CO₂ laser, the material was marked black.

### EXAMPLE 18

When a solid sample of sodium carboxymethylcellulose was irradiated using a Videojet Focus S10 CO₂ laser, the material was marked dark brown.

### EXAMPLE 19

92 g ethanol was used to dissolve 8 g hydroxypropylcellulose, to this 25 g sodium alginate was added and the resulting suspension was ground for 48 hours. When this composition was applied to a lemon, orange, apple, egg or pharmaceutical tablet a white coating was obtained. Irradiation using a Videojet Focus S10 CO₂ laser resulted in legible dark brown/black markings.

### EXAMPLE 20

A mixture of 50 g ethanol and 50 g water was used to dissolve 4.5 g hydroxypropylcellulose, to this 25 g sodium alginate was added and the resulting mixtures was stirred vigorously for 20 minutes. When this composition was applied to a lemon, orange, apple, egg or pharmaceutical tablet a clear coating was obtained. Irradiation using a Videojet Focus S10 CO₂ laser resulted in legible dark brown/black markings.

### EXAMPLE 21

A solution of 2.74 g of manganese acetate tetrahydrate was prepared in deionised water (7 g). Separately, a solution of oxalic acid dehydrate (1.144 g) in deionised water (6 g) was prepared. The oxalic acid solution was added to the manganese acetate solution. A white precipitate of Manganese Oxalate (a 1,2-dicarboxylate) formed immediately and was collected by filtration, washed with 3×5 g deionised water and dried at 55° C. overnight.

### EXAMPLE 22

4.52 g of manganese acetate tetrahydrate was dissolved in 10 g deionised water. Separately, 1.96 g malonic acid was dissolved in 1.5 g deionised water. The solutions were mixed. On standing overnight, a precipitate of manganese malonate hydrate (a 1,3-dicarboxylate) formed which was collected by filtration and washed with 3×2 g deionised water. The precipitate was then dried at 55° C. overnight.

### EXAMPLE 23

Separately, manganese oxalate (2 g) from Example 5 and manganese malonate (2 g) from Example 6 were mixed with Texicryl 13-011 polymer emulsion (4.8 g each). Both products were milled for 3 h using steatite balls, and then coated independently on MWV card using a 2.5 rated wire coating bar (RK coaters) and dried using warm air.

Each coating was exposed imagewise using a CO₂ scribing laser. Manganese oxalate gave no laser imaging activity; by contrast manganese malonate gave legible brown images at 5 W and 8 W laser power. The results indicate that the malonates are more reactive to the CO₂ scribing laser than the oxalates.

### EXAMPLE 24

A 20% by weight solution of sodium heptonate dihydrate (Croda) in deionised water was coated to card manufactured by MeadWestvaco Corporation using a 2.5 rated wire coating bar supplied by RK Coaters. The coating was dried using a warm air to give a colorless layer and then imaged using a CO₂ scribing laser. Legible dark brown alphanumeric images were obtained at powers between 3 and 5 W.

### EXAMPLE 25

A 20% by weight solution of sodium boroheptonate (Croda) in deionised water was coated to card manufactured by MeadWestvaco Corporation using a 2.5 rated wire coating bar supplied by RK Coaters. The coating was dried using warm air to give a colorless layer and then imaged using a CO₂ scribing laser. Legible black-brown alphanumeric images were obtained at powers between 3 and 5 W.

1. A method for marking an object, wherein the object comprises a moiety including both a functional group and a metal ion, wherein the metal ion is capable of reacting with the functional group to cause an internal elimination reaction on irradiation with a laser, to form a reaction product of contrasting colour, and wherein the method comprises directing a laser beam onto the areas of the object to be marked, whereby those areas are marked by the presence of said reaction product.

2. The method according to claim 1, wherein the functional group does not react with metal ions present in any additional substance contained within the object.

3. The method according to claim 1, wherein the functional group includes one or more groups selected from OH and COOH.

4. The method according to claim 1, wherein the moiety comprises a homopolymer or copolymer of a carbohydrate.

5. The method according to claim 4, wherein the moiety comprises a polysaccharide.

6. The method according to claim 4, wherein the moiety comprises a carboxymethylcellulose, an alginate, a pectinate, or mixtures thereof.

7. The method according to claim 4, wherein the moiety comprises an alginate.

8. The method according to claims 4, wherein the metal ion is sodium.

9. The method according to claim 1, wherein the moiety comprises a dicarboxylate.

10. The method according to claim 9, wherein the moiety comprises a malonate.

11. The method according to claim 9, wherein the metal ion is a divalent transition metal cation.

12. The method according to claim 9, wherein the metal ion is Mn²⁺, Co²⁺, Fe²⁺, Ni²⁺, Cu²⁺ or a combination thereof.

13. The method according to claim 1, wherein the moiety comprises the partial formula —CH(OH)CH(OH)CH(OH)COO^{⊖}—.

14. The method according to claim 13, wherein the moiety comprises a gluconate, a heptonate, or mixtures thereof.

15. The method according to claim 13, wherein the metal ion is a monovalent, divalent or trivalent metal cation, or mixtures thereof.

16. The method according to claim 13, wherein the functional group is contained within a borate complex.

17. The method according to claim 13, wherein the metal ion is NH₄⁺, Li⁺, Na⁺, K⁺, Ca²⁺, Mg²⁺, Sr²⁺, Al³⁺ or mixtures thereof.

18. The method according to claim 1, wherein the object is a pharmaceutical or foodstuff, and the reaction product is physiologically acceptable.

19. The method according to claim 1, wherein the object comprises a substrate and, coated thereon, a coating comprising the moiety.

20. The method according to claim 19, wherein the substrate is a tablet or pill and the coating comprises a pharmaceutical agent.

21. The method according to claim 1, wherein the object is wrapped or covered in a filmic material.

22. The method according to claim 1, wherein the object or the coating further comprises a substance comprising a second metal ion that reacts with any functional group that does not undergo the elimination reaction.

23. The method according to claim 22, wherein the amount of substance is sufficient to enable substantially all functional groups to undergo the elimination reaction.

24. The method according to claim 1, wherein the object or the coating additionally comprises an oxyanion-containing compound.

25. The method according to claim 24, wherein the oxyanion-containing compound is a molybdate or a tungstate.

26. The method according to claim 25, wherein the oxyanion-containing compound is ammonium octamolybdate.
